(19) United States
(12) Patent Application Publication
(10) Pub. No.: US 2006/0198636 A1
(43) Pub. Date: Sep. 7, 2006

(54) Wavelength grid for DWDM

(75) Inventors: Gabriel Charlet, Villiers-Le-Bacle (FR); Patrice Tran, Aubervilliers (FR); Haik Mardoyan, Alfortville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/358,312

(22) Filed: Feb. 22, 2006

(30) Foreign Application Priority Data
Mar. 7, 2005 (EP) 05290507.2

(51) Int. Cl. H04J 14/02

(52) U.S. Cl. 398/83

(57) ABSTRACT

In order to allow transmission of higher bitrate optical wavelength channels (C1-C4) over a transport network designed for the transmission of lower bitrate optical wavelength channels (A1-A8), the wavelengths of the higher bitrate wavelength channels (C1-C4) are detuned by at least 30% of the channel spacing (S2) the lower bitrate wavelength channels (A1-A8) with respect to a predefined ITU wavelength grid.

The invention is based on a priority application EP 05290507.2 which is hereby incorporated by reference.

### FIELD OF THE INVENTION

The present invention relates to the field of telecommunications and more particularly to a method of transmitting wavelength multiplexed signals through an optical transport network.

### BACKGROUND OF THE INVENTION

Wavelength Division Multiplexing (WDM) is a technique of combining several optical signals at slightly different wavelengths for the joint transport through an optical transport network. Depending on the bitrate of the optical signals, a minimum channel spacing is required to make sure that all channels can be properly demultiplexed after transmission. As a general rule, the higher the bitrate, the larger is the required channel spacing.

The ITU-T has defined in G.694.1—which is incorporated by reference herein—several wavelength grids with channel spacing of 12.5 GHz, 25 GHz, 50 GHz, and 100 GHz, respectively. The bitrate used in today's WDM transport networks is 10 GBit/s at a channel spacing of 50 GHz. Future transmission networks will make use of 40 GBits/s signals requiring a channel spacing of 100 GHz.

Network elements are required in the transport network to add and drop individual wavelength channels to and from WDM signals, respectively. Such network elements are also known as reconfigurable optical add/drop multiplexers (ROADMs). In principle, a ROADM uses filters or wavelength gratings to extract individual channels and wavelength blockers to switch off dropped channels from the transit signal so that new channels can be added into the wavelength band corresponding to the dropped channel.

Such network elements are designed today for 10 GBit/s at a channel spacing of 50 GHz. With the introduction of 40 GBit/s transmission, all such network elements would have to be replaced or updated to 100 GHz channel spacing, which incurs high costs and is an obstacle for the introduction of 40 GBit/s transmission. It would be very advantageous if old equipment could be reused and 40 Gbit/s could be introduced gradually.

It is thus an object of the invention, to provide a method of transmitting higher bitrate optical wavelength channels over a transport network designed for the transport of lower bitrate optical wavelength channels. Moreover, it is an object of the present invention to provide an network element, which is easily adapted to the transport of lower and higher bitrate optical channels, both.

### SUMMARY OF THE INVENTION

These and other objects that appear below are achieved by detuning with respect to the ITU wavelength grid the wavelengths of a higher bitrate WDM signal by at least 30% of the channel spacing of a lower bitrate WDM signal.

In particular, the method provides transmission of a wavelength multiplexed signal carrying higher bitrate wavelength channels having a first channel spacing through an optical transport network designed for the transport of wavelength division multiplexed signals carrying lower bitrate wavelength channels having a second channel spacing and conforming with a predefined wavelength grid. It contains the steps of:
generating optical signals at wavelengths corresponding to the higher bitrate wavelength channels, wherein the wavelengths are detuned from corresponding wavelengths of the predefined wavelength grid by at least 30% of said second channel spacing and
combining the optical signals to form the wavelength multiplexed signal for transmission.

With respect to the optical network element, the object is achieved by providing a control means, which configures the optical network element to block two adjacent wavelengths from the predefined ITU wavelength grid to extract one of the optical signals contained in the wavelength multiplexed signal

According to another aspect of the invention, a method is provided for transmitting a wavelength multiplexed signal carrying wavelength channels having a narrower channel spacing through an optical transport network designed for the transport of wavelength division multiplexed signals carrying wavelength channels having a wider channel spacing and conforming with a predefined wavelength grid. The method comprises the steps of:
generating optical signals at wavelengths corresponding to said narrower channel spacing, wherein said wavelengths are detuned from corresponding wavelengths of said predefined wavelength grid by at least 30% of said narrower channel spacing and
combining said optical signals to form said wavelength multiplexed signal for transmission.

In this scenario, any two adjacent wavelength channels can be blocked by convention network elements such as ROADMs.

### BRIEF DESCRIPTION OF THE DRAWINGS

Preferred embodiments of the invention will be described below with reference to the accompanying drawings, in which

FIG. 1a shows a predefined wavelength grid for 10 GBit/s transmission;

FIG. 1b shows the wavelength grid as recommended by ITU-T for 40 GBit/s transmission;

FIG. 1c shows an optimized wavelength grid according to the invention;

FIG. 2 shows the principle of operation of a reconfigurable optical add/drop multiplexer;

FIG. 3a shows wavelength blocking performed by a reconfigurable optical add/drop multiplexer the in the predefined wavelength grid for 10 GBit/s transmission;

FIG. 3b shows the same wavelength blocking but with a 40 GBit/s channel using the ITU-T wavelength grid;

FIG. 3c shows the same wavelength blocking for a 40 GBit/s channel but using the optimized wavelength grid according to the invention;

FIG. 4 shows a measurement curve of a Q-factor using the invention;

FIG. 5 shows the impact of wavelength detuning on various wavelengths using the invention,

FIG. 6 shows a prior art optical transmission system with transmitter and receiver, and

FIG. 7 shows a second aspect of the invention.

### DETAILED DESCRIPTION OF THE INVENTION

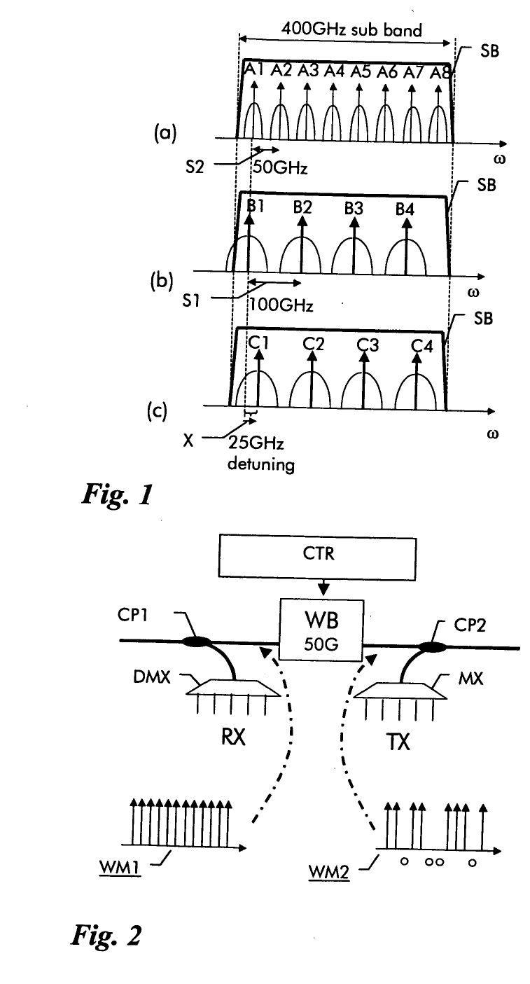

FIG. 1a shows an example of a WDM signal in a 400 GHz sub-band SB carrying 8 wavelength channels A1-A8 with 10 GBit/s optical signals. The individual optical signals have due to their modulation with the 10 GBit/s data. a certain width. This requires that a 50 GHz spacing S2 is applied to clearly separate the individual channels in the WDM signal.

FIG. 1b shows the situation when 4 wavelength channels B1-B4 with 40 GBit/s optical signals are combined at wavelengths that correspond to the ITU-T wavelength grid. Since the individual optical signals are broader than for in the case above due to their higher bitrate modulation, the wavelength spacing S1 between the channels must be larger, i.e., 100 GHz. As another consequence, the resulting WDM signal will not fit entirely into the same sub-band SB. As can be observed, channel B1 reaches out of the sub-band SB at the left end of the wavelength scale.

A basic idea of the invention is therefore, to use for 40 GBit/s signals a wavelength grid which is shifted with respect of the ITU-T wavelength grid. This is shown in FIG. 1c. The WDM signal contains four wavelength channels C1-C4, which are shifted with respect to the wavelengths of channels A1, A3, A5, and A7, respectively, by 25 GHz, i.e., by an amount X that corresponds to half of the channel spacing of the 10 GBit/s grid. Due to this detuning, the four optical signals from the four wavelength channels C1-C4 fit perfectly into the 400 GHz sub-band SB.

FIG. 2 shows a reconfigurable add/drop multiplexer (ROADM). It contains a first coupler CP1 connected to an incoming line fiber. The main output of the coupler CP1, which acts as a passive optical splitter, is connected to a wavelength blocker WB, while the splitter output of the coupler CP1 is connected to a wavelength demultiplexer DMX. The output of the wavelength blocker WB is connected to a first input of a second optical coupler CP2, a second input of which is connected to a wavelength multiplexer MX. The output of coupler CP2 is connected to an outgoing line fiber. A controller CTR controls the configuration of the wavelength blocker WB.

The signal fraction split off by coupler CP1 is fed to demultiplexer DMX, which separates the individual wavelength channels contained therein, selects those channels that are configured to be dropped, and makes these available at corresponding tributary ports. The transit signal, i.e. the main signal coming from the coupler CP1 still contains these channels to be dropped. This signal is shown schematically as signal WM1 in FIG. 2. In order to empty these wavelength channels, so that new signals can be added therein, the transit signal is fed to wavelength blocker WB.

A wavelength blocker is a device which is capable of selectively blocking, passing, or attenuating individual channels, while simultaneously passing transit channels with minimal attenuation. A wavelength blocker can be implemented using a plurality of shutters arranged between a demultiplexer and a multiplexer such as described for example in U.S. Pat. No. 6,504,970. As the ROADM is designed for 10 GBit/s transmission, wavelength blocker WB has shutters or “gates” for each 50 GHz wavelength channel. In the present embodiment, four wavelength channels are to be dropped and thus wavelength blocker WB closes the corresponding four gates to block these wavelengths. The resulting transit signal is shown schematically as signal WM2 in FIG. 2. Multiplexer MX assembles new optical signals at wavelengths which correspond to these blocked wavelengths and adds these via coupler CP2 to the transit signal.

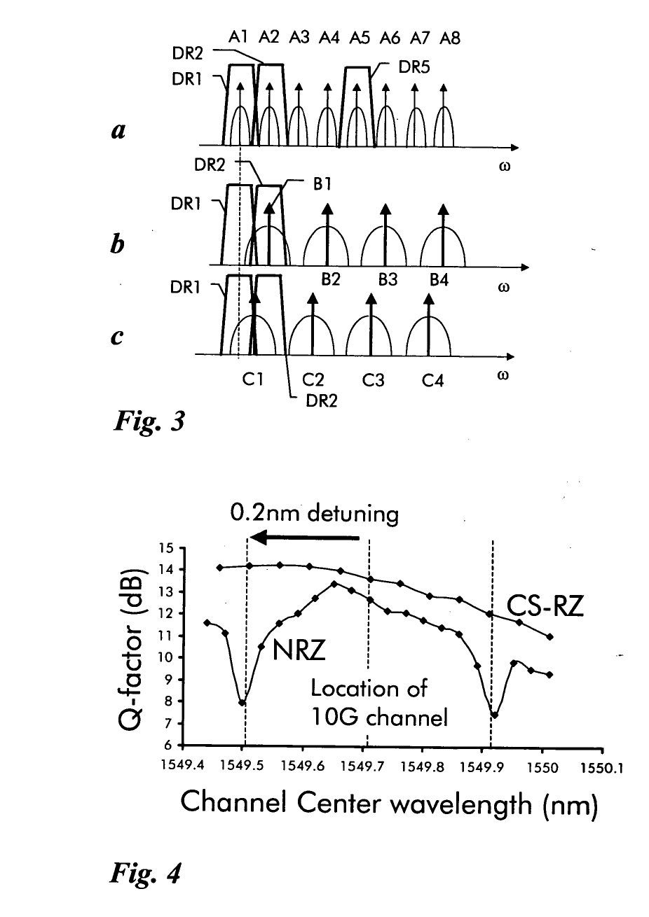

The relation of the wavelength blocker and the wavelength grid is shown in FIG. 3a. Similar to FIG. 1a, a WDM signal contains 8 wavelength channels A1-A8 with 10 GBit/s data modulation at a spacing of 50 GHz. Each gate of the wavelength blocker corresponds to a certain bandpass filter. By way of example, three bandpasses DR1, DR2, and DR5 are shown. When these three gates are closed, the corresponding wavelength channels A1, A2, and A5, respectively, will be erased from the WDM signal, while all other channels, i.e., A3, A4, A6, A7, and A8, may pass.

FIG. 3b shows the impact of the wavelength blocker on wavelength channels B1-B4 with 40 GBit/s data modulation at a channel spacing of 100 GHz, as defined by ITU-T. Channels B1-B4 correspond in this example to the wavelengths of channels A2, A4, A6, and A8, respectively. Due to the higher bitrate modulation, the optical signals are broader than for 10 GBit/s modulation. Therefore, one bandpass of the wavelength blocker does not attenuate one full wavelength channel. Since the optical signal from one wavelength channel overlaps the corresponding bandpass of the wavelength blocker on both sides, three adjacent gates need to be closed to erase this wavelength signal, but which would affect the neighboring channels, as well. Therefore, use of the ITU-T wavelength grid would necessitate the replacement of all wavelength blockers in the network.

Conversely, FIG. 3c shows the impact of a wavelength blocker on a WDM signal shifted with respect to the ITU-T grid in a manner as described above. The wavelengths C1-C4 are shifted with respect to the ITU-T grid by 25 GHz. Due to this detuning, the wavelengths lie in the middle between two adjacent bandpasses of the wavelength blocker. Thus by closing for instance gates DR1 and DR2, the complete wavelength signal C1 would be erased from the WDM signal without affecting the neighboring wavelength signal C2. This means that existing wavelength blockers designed for 10 GBit/s transmission can be re-used for 40 GBit/s transmission by simply closing two gates rather than only one per wavelength channel. This enables a smooth transition from 10 GBit/s to 40 GBit/s without need to replace all equipment at once. Moreover, the invention will enable also the use of mixed WDM signals in which 10 GBit/s and 40 GBit/s channels are used in parallel.

FIG. 4 shows in a measurement curve for one channel the impact of detuning the wavelength on the performance of the system. The measurement setup uses 10 spans of standard LEAF fiber and two 50 GHz wavelength blockers, which have to be passed by an optical test signals.

The lower curve shows an optical test signal modulated with 40 GBit/s data using a NRZ modulation scheme (non-return-to-zero). A detuning of 25 GHz corresponds to 0.2 nm on the wavelength scale. As can be seen, the Q-factor, which stands for the system performance, is significantly degraded at a shift of 0.2 nm, i.e., when the carrier lies between two gates of the wavelength blocker. A detuning of 0.15 nm (i.e. 30% of the 50 MHz spacing) should be sufficient in this case to achieve at least some of the benefits described above.

The upper curve is a measurement of an optical test signal modulated with 40 GBit/s data using carrier-suppressed (CS-) RZ modulation (return-to-zero). As can be seen from FIG. 4, when using CS-RZ modulation, a detuning of 0.2 nm does not affect the system performance at all. The slight dependence of the Q-factor from the wavelength is due to power excursion of the channel in the experiment, which could in principle be avoided.

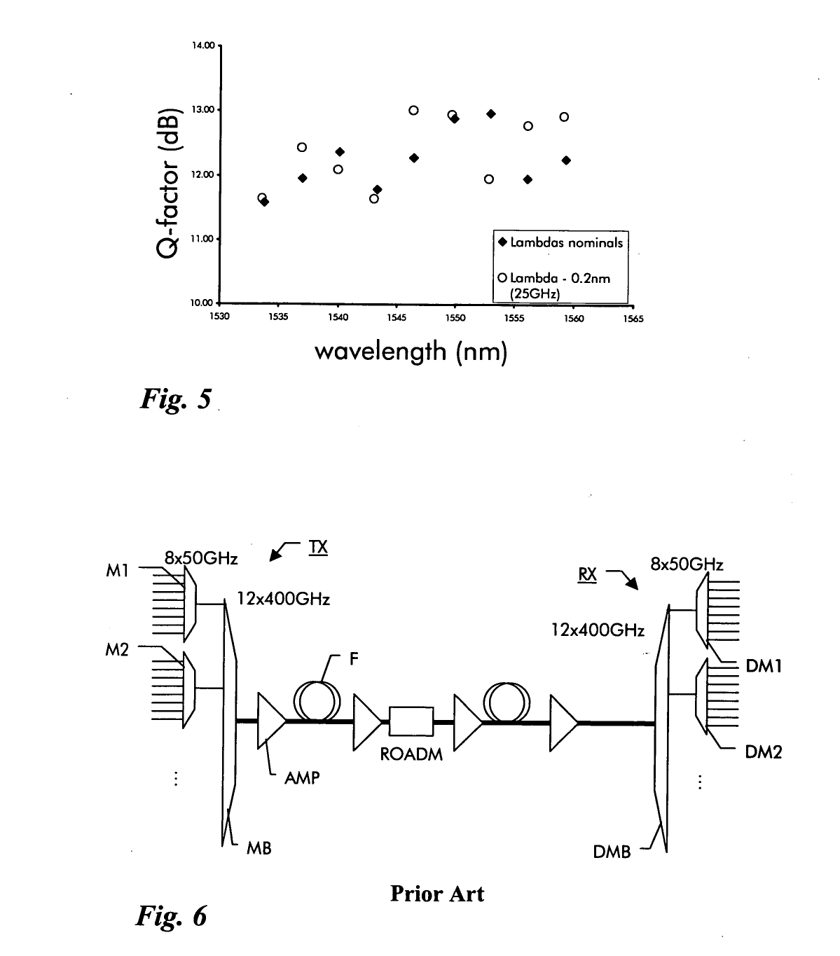

FIG. 5 shows the impact of wavelength detuning on the Q-factor for ten wavelength channels using CS-RZ modulation. The black diamonds represent the un-tuned wavelength channels and the open circles stand for the wavelength channels detuned by 0.2 nm. The measurement shows that no significant performance degradation can be observed.

As has been found out, carrier-suppressed modulation schemes such as CS-RZ are preferred over NRZ modulation for the purpose of the invention. Another modulation scheme that will work fine with the invention is DPSK (differential phase shift keying) or RZ-DPSK. It should be understood that carrier-suppressed modulation schemes benefit most from the channel shift according to the invention. For non-carrier-suppressed modulation schemes, the central carrier might just be located on a “dip” between two “pixels” of the wavelength blocker, which leads to a higher insertion loss.

According to the invention 40 GBit/s optical transmitters can now be used in a network system including wavelength blockers designed for 10 GBit/s transmission, provided that their emission wavelength is detuned as described above. In order to make network elements such as ROADs or reconfigurable optical crossconnects, which include wavelength blockers, compatible with the invention, the respective network element's controller that controls the individual gates of the wavelength blocker need to be adopted to close two adjacent gates to block one of the 40 GBits/s optical signals contained in the wavelength multiplexed signal. The controller is typically a programmable device such as a computer workstation, so that the necessary changes can be made by a simple software update. Moreover, the invention affects the transmitter side in a transport network, since the transmitters must be adapted to emit optical signals at the detuned wavelengths, as well as the receiver sie, which must be adapted to demultiplex the detuned wavelength channels.

FIG. 6 shows a prior art WDM system using band mux and demux. A transmitter TX comprises a band multiplexer MB, which combines 12 sub-bands of 400 GHz width. Each sub-band comprises 8 wavelength channels at a channel spacing of 50 GHz. For each sub-band, a multiplexer M1, M2, . . . is provided. The multiplexed signal comprising 12×8 channels is fed to a transmission line, which comprises a number of optical amplifiers AMP and fiber spans F. A receiver RX comprises a band demultiplexer DMB, which splits the received WDM signal up into 12 sub-bands of 400 GHz width. Each sub-band is then transferred to a respective demultiplexer DM1, DM2, . . . , which splits the sub-band up into its 8 constituent single wavelength signals at the channel spacing of 50 GHz.

Somewhere in the transmission line, there is a reconfigurable optical add/drop multiplexer of the type as described with reference to FIG. 2. It should be understood that according to the invention, transmitter TX and receiver RX will be modified to support optical signals at 40 GBit/s bitrate and with a channel spacing of 100 GHz but with the wavelength shift with respect to the 50 GHz wavelength grid as described above.

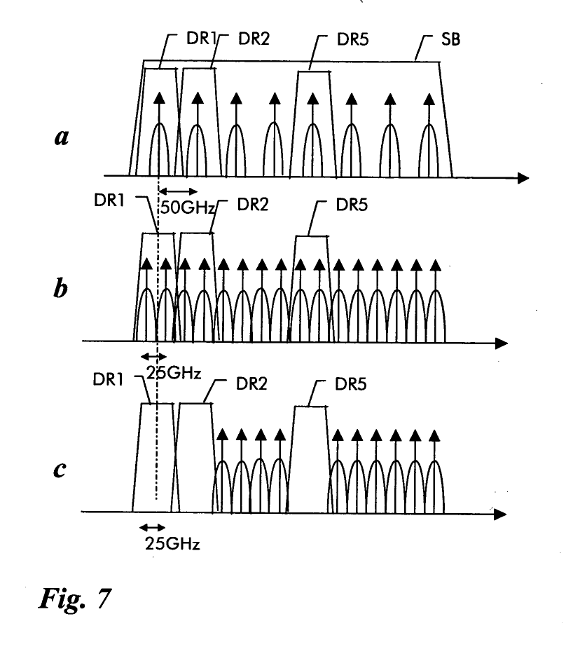

Another aspect of the present invention is shown in FIG. 7. In FIG. 7a, the 400 GHz sub-band SB is occupied by 8 conventional 10 GBit/s wavelength channels at a channel spacing of 50 GHz. FIG. 7b proposes to use 16 wavelength channels at a channel spacing of 25 GHz, only, but having a wavelength shift of half a channel spacing, i.e., of 12.5 GHz with respect to the ITU wavelength grid.

In this scenario, two channels will be dropped or added per “pixel” of the wavelength blocker. Pixels DR1, DR2, and DR5 of the wavelength blocker are shown in FIG. 7b, which cover channels 1-4, 9, and 10, respectively, of the 16 channels in the sub-band SB. In FIG. 7c, these channels are removed from the sub-band SB by the wavelength blocker. In this aspect of the invention, the same basic idea, i.e. wavelength shift of about half the channel spacing, is therefore implemented in a similar context and achieves the same benefits, i.e., use of existing ROADMs for higher bandwidth system (2×8 channels instead of 1×8 per sub-band).

Instead of a wavelength blocker, a Wavelength Selective Switch (WSS) can equally be used in the context of the invention. A Wavelength Selective Switch (WSS) is a 1×N device, which has one input and N outputs (often 9). Each input wavelength can be directed to any one of the N output ports. Several wavelengths can also be sent to the same outputs. Output wavelengths can be independently attenuated and blocked.

1. A method of transmitting a wavelength multiplexed signal carrying higher bitrate wavelength channels having a wider, regular channel spacing through an optical transport network designed for the transport of wavelength division multiplexed signals carrying lower bitrate wavelength channels having a narrower channel spacing and conforming with a predefined wavelength grid, said method comprises the steps of:
generating optical signals at wavelengths corresponding to said higher bitrate wavelength channels, wherein said wavelengths are detuned from corresponding wavelengths of said predefined wavelength grid by at least 30% of said narrower channel spacing and
combining said optical signals to form said wavelength multiplexed signal for transmission.

2. A method according to claim 1, comprising the step of:
in the transport network extracting at least one of the optical signals contained in said wavelength multiplexed signal by blocking the wavelength channel corresponding to said optical signal to be extracted using a reconfigurable optical add/drop multiplexer, wherein in said reconfigurable optical add/drop multiplexer two adjacent wavelengths from said predefined wavelength grid are blocked.

3. A method according to claim 1, wherein said wavelengths are detuned from corresponding wavelengths of said predefined wavelength grid by 50% of said narrower channel spacing.

4. A method according to claim 1, wherein said optical transport network is designed for transmission of 10 GBit/s data signals at a channel spacing of 50 GHz and wherein said optical signals to be transported are generated at wavelengths detuned by 25 GHz with respect to said wavelength grid at a channel spacing of 100 GHz and carry 40 GBit/s data signals.

5. A method according to claim 1, wherein said optical signals are modulated using a carrier-suppressed modulation scheme.

6. A method according to claim 1, wherein said optical signals are modulated using a DPSK-based modulation scheme.

7. A method according to claim 1, wherein said wavelength multiplexed signal to be transmitted is a mixed signal comprising at least one of said detuned higher bitrate wavelength channel and at least one non-detuned lower bitrate wavelength channel.

8. An optical transmission system comprising
at least one wavelength blocker or wavelength selective switch for blocking individual wavelengths from a wavelength division multiplexed signal, wherein the wavelength blocker or wavelength selective switch is designed for operation with wavelength division multiplexed signals carrying lower bitrate wavelength channels having a narrower channel spacing and conforming with a predefined wavelength grid; and
an optical transmitter for generating a higher bitrate optical signal at a wavelength corresponding to a higher bitrate wavelength channel of the wavelength division multiplexed signal to be transmitted, wherein said higher bitrate wavelength channels have a wider channel spacing and wherein said wavelengths are detuned from corresponding wavelengths of said predefined wavelength grid by at least 30% of said narrower channel spacing.

9. An optical network element comprising a wavelength blocker or a wavelength selective switch for blocking individual wavelengths from a wavelength division multiplexed signal carrying higher bitrate wavelength channels having a wider channel spacing, wherein the wavelength blocker or wavelength selective switch is designed for operation with wavelength division multiplexed signals carrying lower bitrate wavelength channels having a narrower channel spacing and conforming with a predefined wavelength grid; and a control means for controlling said wavelength blocker or wavelength selective switch which is adapted to configure said wavelength blocker or wavelength selective switch to block two adjacent wavelengths of said predefined wavelength grid to extract one of said higher bitrate wavelength channels.

10. A method of transmitting a wavelength multiplexed signal carrying wavelength channels having a narrower, regular channel spacing through an optical transport network designed for the transport of wavelength division multiplexed signals carrying wavelength channels having a wider channel spacing and conforming with a predefined wavelength grid, said method comprises the steps of:
generating optical signals at wavelengths corresponding to said narrower channel spacing, wherein said wavelengths are detuned from corresponding wavelengths of said predefined wavelength grid by at least 30% of said narrower channel spacing and
combining said optical signals to form said wavelength multiplexed signal for transmission.

11. A method according to claim 10, wherein said wavelength signals have a bitrate of 10 Gbit/s and a channel spacing of 25 GHz, and wherein said wavelengths are detuned from corresponding wavelengths of said predefined wavelength grid by 12.5 GHz.
